(19) United States
(12) Patent Application Publication
(10) Pub. No.: US 2003/0141025 A1
(43) Pub. Date: Jul. 31, 2003

(54) Control system for blinds in motor vehicles

(76) Inventors: Werner P. Schlecht, Vaihingen/Enz (DE); Holger Seel, Aidlingen (DE); Thomas Laudenbach, Rottenburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/111,343

(22) PCT Filed: Aug. 10, 2001
(86) PCT No.: PCT/DE01/03090

(30) Foreign Application Priority Data
Aug. 25, 2000 (DE) 10041709.4

(51) Int. Cl. B60J 1/20

(52) U.S. Cl. 160/370.22

(57) ABSTRACT

A window shade control for window shades (17, 28) of motor vehicles contains a control arrangement (23, 71). The control arrangement (23, 71) receives signals from a switch (41, 42), which is to be manually operated by the driver, or vehicle occupant, in order to be able to arbitrarily retract or extend the window shade (17, 18).

Signaling means (45, 46, 48, 51) are additionally provided, which react to other external stimuli in order to bring the respective window shade into a state which best meets the respective reported external stimulus independently of the actuation by the driver.

A rear window shade for motor vehicles is known for example from EP 0 240 747 C1. The window shade has a rotatably seated windup shaft, on which an edge of a window shade web is fastened. The window shade web can be extended with the aid of two levers, which are pivotably seated in the vicinity of the windup shaft and act on a drop rail affixed to the window shade web. An electrical drive mechanism, which acts on the pivot levers, is provided for extending the window shade web.

This known rear window shade is installed by the vehicle manufacturers in the area of the rear window ledge. For actuation, i.e. for the electrical extension and retraction, a switch is provided in the dashboard, which must be operated by the driver in order to put the electric motor into appropriate operation. Customarily time function controls or current-dependent controls are provided in order to shut off the motor current when the completely extended or the retracted position has been reached.

Based on this, it is the object of the invention to create a window shade control for window shades of motor vehicles which offers an increased ease of operation to the user.

This object is attained in accordance with the invention by means of the window shade control having the characteristics of claim 1.

Because a stimulus-dependent signaling means is assigned to the control device, it can be controlled independently of the driver, or user of the vehicle, but depending on other stimuli. Conditions of the vehicle and its environment, which make a window shade position other than the existing one appear practical, and among which is not the specific wish of the driver or user for a particular setting of the respective window shade, are understood to be other stimuli.

By means of the novel arrangement it is possible to extend the respective window shade even if there is no one in the vehicle and if, on the other hand, it is detected that the sunbeams are too strong which make the shading of the vehicle passenger compartment appear to be advantageous in order to prevent excessive heating.

Front window shades of passenger cars, and in particular commercial vehicles, can be opened or closed without any action by the driver, namely as a function of the environmental conditions and the position of the ignition lock, or the locking condition of the door lock.

On the other hand, a window shade which had been extended by the driver can be retracted if the particular operational situation of the motor vehicle requires it. An example of this is the rear window shade which, for example, is automatically pulled down when the driver selects the reverse gear, so that visibility to the rear is considerably improved.

Another example of use is the shade or the displaceable cover plate for covering the trunk of station wagons. It is advantageously moved into the opened position when the tailgate is opened.

Furthermore, an electrically actuated separating screen can be operated in this way. In this case the result is the tilting down or raising of the rear set back.

In this sense, it is intended by the term window shades to mean all webs or nets which can be wound up and/or displaced in a motor vehicle.

In addition to the stimulus-dependent control, a check, or control, intended by the user can be useful. In this case a second signaling means is additionally provided, which is actuated by the driver or user and presets the position of the window shade. The additional stimuli can override, the setting of the window shade preset by the user.

The simplest control essentially consists of a commutating switch which is designed in a special way, so that it is possible to extend the window shade web additionally via an appropriate set of switches with the aid of an additional switching signal emanating from a sensor.

In this case the additional input at the switch would be an appropriate control input, through which the first signaling means are connected.

However, electronic control devices are also conceivable, which have a current supply input and a current output, to which the electric motor of the drive mechanism is connected. The control device moreover has one or two control inputs, to which the respective signaling means are connected, or to which the signals from the signaling means are fed in.

The control device can furthermore have its own microprocessor, so that the control device becomes essentially independent of the rest of the motor vehicle control mechanism. This solution allows a modular retrofitting of the existing systems.

Another variation consists in implementing the control device in the central motor vehicle control mechanism, which aids in avoiding additional electronic devices. It is possible here to fall back on the processor(s) of the central control mechanism, wherein the actual control device for the window shade practically becomes a part of the program running in the central control mechanism. The second signaling means, which are to be actuated arbitrarily by the driver, can be constituted by a switch or a key, or can be a variable program quantity, whose value is changed by a switch or key. This switch or key can again be arbitrarily operated by the driver.

The same possibilities exist correspondingly also for the first signaling means which operate as a result of stimuli. For example, a switch or key can be connected with the gearshift or gear selection lever, so that when reverse gear is selected, the window shade is inevitably retracted.

A combination with the light switch is also conceivable, so that the window shade is also retracted with the onset of twilight.

Another sensor, for example a magnetoresistor or a Hall sensor, can be employed in place of a switch for detecting the position of switches or of the selection lever. Here the said switch or selection lever is only an example for actuating members of a motor vehicle which are monitored for automatically operating the window shade, a rear window shade or a side window shade.

In an electronic gear control the second signaling means, which operate in a stimulus-triggered manner, can also be an electrical signal obtained from the central motor vehicle control mechanism, or an appropriate variable program quantity.

Sensors are also possible as first signaling means in order to automatically operate the drive mechanisms of the respective window shades as a function of light. Such sensors can be light- and/or heat-sensitive sensors, for example photoelectric diodes, photoresistors, temperature-dependent resistors and the like.

The first signaling means can also include signals by means of which it is detected whether the vehicle is at rest or in an operative state. Useful criteria here is the question whether the ignition has been switched on. Control can take place in such a way that, with the ignition switched on, the light- or temperature-sensitive sensors are switched off, and instead the control device acts as a result of the actuation of the gearshift or gear selection lever. With the ignition switched off, the position of the gearshift or gear selection lever is unimportant and the window shades are exclusively controlled as a function of what is reported to the control mechanism by the light- or temperature sensors. The status of doors, tailgates or door locks can be further criteria. The load conditions of seats could also be of importance.

The program can also be supplemented in that the setting of the window shades caused by the first signaling means is overridden if within a predeterminable time the first signaling means are again actuated by the driver in accordance with a specially desired state of the respective window shades.

The above variations constitute only a small selection from a multitude of conceivable alternatives, change options and environmental, or operating stimuli. Therefore such combinations of characteristics of the dependent claims among themselves and in combination with the main claim are also claimed, which are not the subject of a particular exemplary embodiment.

Exemplary embodiments of the subject of the invention are represented in the drawings. Shown are in:

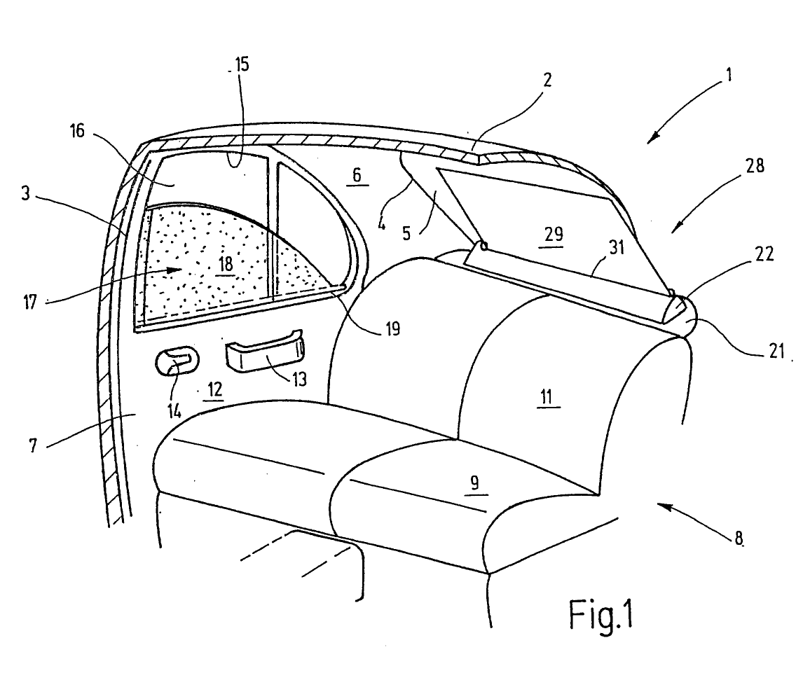

FIG. 1, a plan view of a motor vehicle with a side window shade and a rear window shade in a greatly schematized perspective representation,

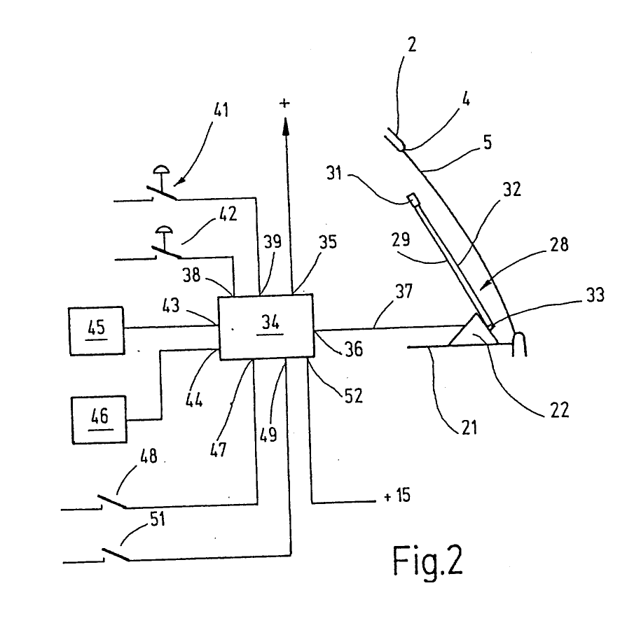

FIG. 2, a greatly schematized block diagram for the control device of the window shade,

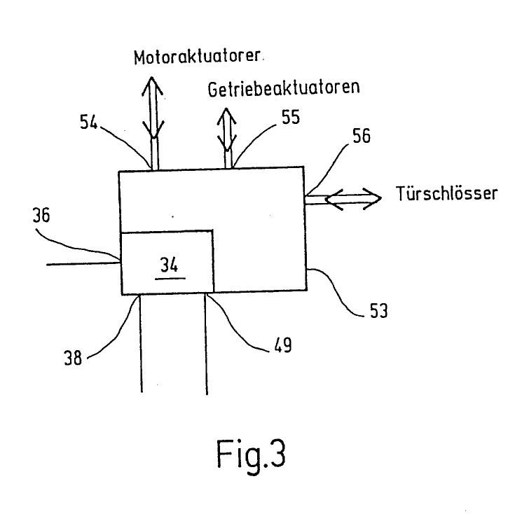

FIG. 3, another block diagram of a window shade control device in connection with a central motor vehicle control device in a greatly schematized block diagram,

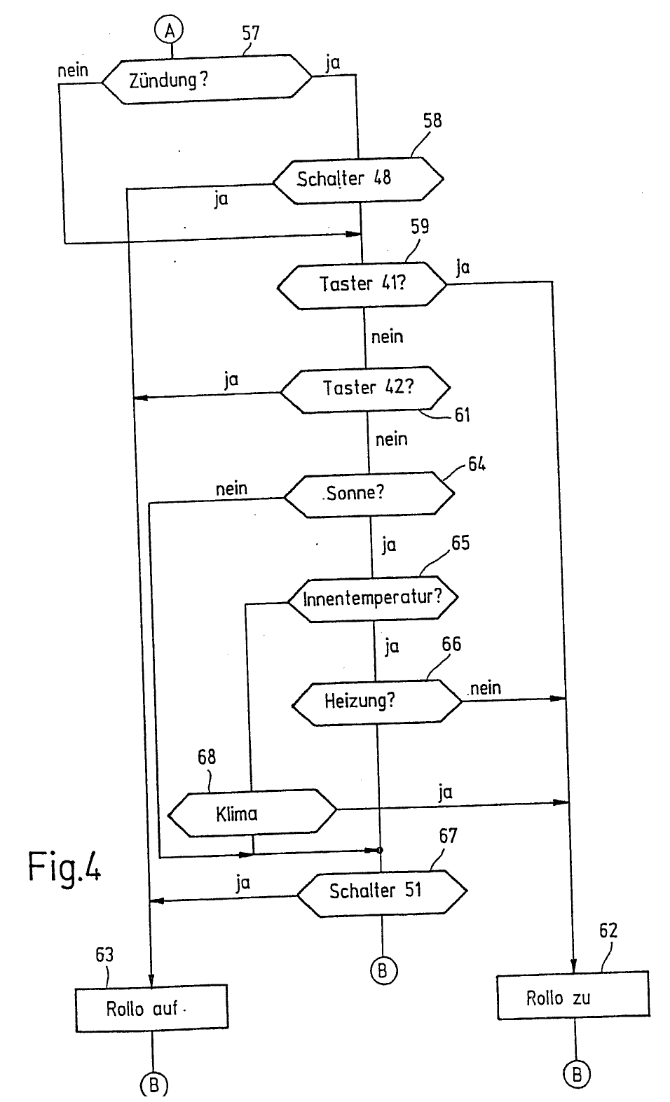

FIG. 4, a simplified flow diagram, such as can be run in a microprocessor or microcontroller in the exemplary embodiments of FIGS. 3 and 4, and

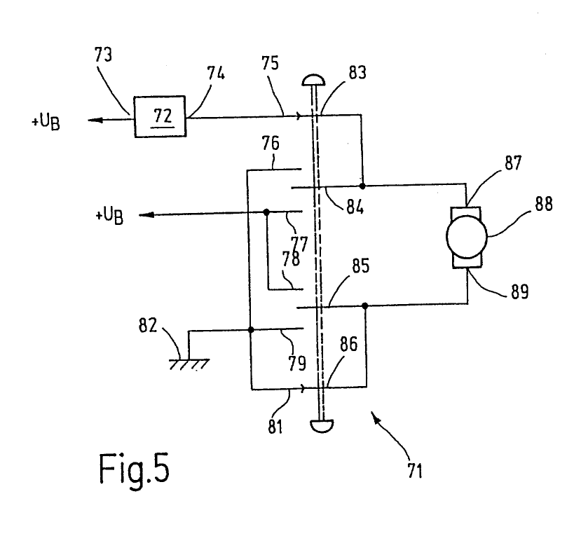

FIG. 5, a greatly simplified circuit arrangement, consisting of an electromechanical switch and an additional first signaling means.

FIG. 1 represents a broken-open, cut interior area of a passenger car. The drawing shows a view on the right inside, which is laterally reversed in respect to the left inside, not represented. The representation is simplified, for example interior body structures, such as reinforcement and fastening means, are not represented, since their representation is not required for explaining the invention.

The represented section 1 of the body has a roof 2, from the side of which a B-column 3 leads downward to a base group, not represented. A corresponding B-column should be imagined on the broken-away side of the vehicle. At is rear edge, the roof 2 makes a transition into a rear window opening 4, into which a rear window 5 has been inserted. The rear window opening 4 terminates at the side at a C-column 6, which is located at a distance from the B-column 3. A rear right side door 7 is hinged in a known manner on the B-column 3 between the B-column 3 and the C-column 6.

A rear seat bench 8 is located at the height of the rear right side door 7, elements of which are a seat surface 9 and a rear seat back 11.

The inside of the side door 7 facing the interior is provided with interior paneling 12, on which a door handle 13 is fastened and into which an actuating lever 14 has been embedded for opening the lock of the side door 7.

The side door 7 has a window opening 15 above the interior paneling 12. A side window pane 16, which can be lowered in a known manner, is located in the window opening 15.

The side door 7 is provided with a side window shade 17, whose window shade web 18 has been partially extended in the representation of FIG. 1 in order to protect in this way the area of the interior of the passenger compartment against lateral sunbeams. The window shade web 18 runs through a slit 19 provided underneath the window opening 15.

The design of the side window shade 17 is described in the not previously published patent application DE 100 05 970.

In addition to the side window shades shown, the vehicle can also be equipped on both sides with window shades, for example also in the area of the front doors.

A rear window shelf 21 is located behind the rear seat back 11, which mostly fills the space between the rear seat back 11 and the lower edge of the rear window 2. A housing 22 of a rear window shade 23 is arranged on this rear window shelf 21. The rear window shade 28 has a window shade web 29, which is shown in the extended state and is pulled out of a slit 31 of the housing. The rear window shade 28 is designed, for example, in the way extensively represented in EP 0,240 747 C1.

These window shades shown are used to reduce the influx of sunlight into the interior of the motor vehicle in order to reduce heating as a result of a greenhouse effect.

FIG. 2 shows a block diagram of a partially automated operation of the window shade. The control of the rear window shade 28 is shown here by way of example. It is understood that the explanation provided also correspondingly applies to the side window shades.

In accordance with the prior art, a rotatably seated windup shaft is located in the housing 22, on which an edge of the window shade web 29 is fastened. The windup shaft is biased in the winding-up direction of the window shade web 29 with the aid of a spring drive. A traction rail 31, on which pivot levers 32 which are seated at 33 on the housing 22 act, is fastened on the other edge of the window shade web 29. Pivoting of the pivot levers 32 is performed via appropriate gears with the aid of an electric motor, not shown in detail. The electric motor is a permanently excited d.c. motor, whose direction of rotation is defined by the polarity of the current supply to which it is connected.

The control contains an actual control device or a control arrangement 34 with a current supply input 35, which is to be connected to the on-board electrical system, as well as a current outlet 36, which is connected via a double-pole connecting cable 37 with the electric motor of the rear window shade 28.

Two further inputs 38 and 39 are connected by means of appropriate lines with two manual keys 41 and 42. The manual keys 41 and 42 are, for example, keys on a common rocker and are intended to be manually operated by the user of the vehicle, or also another vehicle passenger.

The two manual keys 41 and 42 are used as signaling devices for defining the direction of movement, or the state of the rear window shade 28, as a function of their state.

Two further inputs 43 and 44 are connected via respective lines with a light sensor 45 and a temperature sensor 46. The light sensor 45 consists of a photodiode or a cadmium sulfide photoresistor, for example, while the temperature sensor can be a temperature-sensitive resistor, a PCT- or an NTC-resistor.

Its fifth input 47 is connected via a respective line with a switch 48, which is connected with the gearshift or gear selection lever of the motor vehicle. One input is connected with a switch 51, which is actuated by the tailgate of the vehicle, if the vehicle is a station wagon or a passenger car with a large hatch, wherein the rear window shown is integrated into the hatch.

Finally, an input 52 is connected with the +15 terminal of the ignition lock, or the ignition coil, in order to signal to the control arrangement 34 whether or not the vehicle is in operation.

The sensor 45 and 46, as well as the switches 48 and 51, and the electrical signal at the input 52 represent further signaling means, whose state is stimulus-dependent. By “stimulus-dependent” it is intended to identify here all stimuli which are transmitted to the control arrangement 34 and are the result of the operational status of the vehicle, as well as environmental conditions, with the exception of the special wish of passengers in the vehicle regarding the operating position of the respective window shade(s).

The mode of functioning of the window shade control device is as follows:

If the user of the vehicle wishes to extend the rear window shade 28, he briefly operates the key 41, by means of which a current pulse reaches the input 39 of the control arrangement 34. The latter then switches the supply voltage received from the input 35 with the required polarity through to the output 36, so that the motor of the rear window shade 28 receives current of the required polarity through the double-pole line 37. By means of this the motor is put into motion and it pivots the two levers 32 in the direction of extending the window shade web 29.

The control arrangement 34 keeps the current supply for the motor of the rear window shade 28 switched on for a defined length of time, which is assuredly longer than the rear window shade 28 requires for complete extension.

When the rear window shade 28 arrives at the mechanical stops, the movement of the motor is blocked and a blocking current appears. At the end of the above mentioned time, which is fixedly preset in the control arrangement 34, the motor current is switched off.

The length of time over which the motor is supplied with current is independent of how long the user keeps the key 41 actuated.

If the user wishes to retract the rear window shade 28, he actuates the key 42 in a pulsed manner. Thereupon the control arrangement 34 switches the voltage present at the input 35 through to the output 36 with an appropriate polarity. The polarity is the reverse of the polarity required for extending the window shade web 28.

During retraction the electric motor of the rear window shade 28 is again supplied with electrical energy over a predetermined length of time. In the control arrangement 34 the length of time is calculated to be such, that the rear window shade 28 can assuredly be retracted before the current supply for the motor is switched off.

Depending on the programming of the control arrangement 34 it is also possible, if desired, to first make a check to determine whether the vehicle is in operation before a function corresponding to the keys 41 and 42 is executed. For this purpose the signal at the input 42 is interrogated. With the ignition switched on, or with the engine running, a voltage is present at the +15 terminal of the ignition lock, or of the ignition coil, in order to signal that the vehicle is in operation. The manual actuation of the rear window shade 28 by means of the key 41 and 42 can be blocked as a function of this stimulus, i.e. actuating the key 41 and 42 does not result in the provision of a current to the motor by the control arrangement 34.

The light sensor 45 is provided to increase the ease of operation. For example, the light sensor 45 is integrated into the rear window shelf 21 and oriented in such a way that sunbeams can fall on it. In this way the light sensor 45 is able to signal the control arrangement 34 whether or not there is a strong influx of sunlight with the danger of heating the interior of the vehicle. If this situation occurs, which is determined by the control arrangement 34 by means of the light sensor 45, the control arrangement 34 itself sees to it, without an actuation of the key 41, that current for the motor of the rear window shade 28 is provided at the output 36, namely of a polarity corresponding to the extension of the window shade web 29.

A limitation of the current, chronological and as to the amount, is also provided during automatic extension and is controlled by the light sensor 45, such as had already been described above in connection with the keys 41 and 42.

The light sensor 45 can be at a location which, after the window shade web 29 has been extended, is always shaded by the window shade web 41 regardless of the position of the sun. So that in this case the window shade web 29 does not confuse the control arrangement 34, the control arrangement only recognizes the appearance of a strong influx of sunlight with the aid of the light sensor 45. A subsequent disappearance of the influx of sunlight because of the shading by means of the window shade web 29 does not result in the retraction of the rear window shade 28.

However, it is also conceivable to attach the light sensor 45 at a location at which the sunlight can be continuously measured. It is possible in this way to automatically retract the rear window shade 28 even if the strong influx of sunlight disappears at the respective window. For this purpose the control arrangement 34 makes a check, similar to the one during extension, of the electrical signal reported by the light sensor 45 by means of an appropriate threshold value and then turns on the current at the output 36 for an appropriate length of time.

However, with very low outside temperatures a greenhouse effect occurs, but it does not affect the well-being of the occupants of the vehicle. In such a case the rear window shade, or another window shade, need to be extended. The temperature sensor 46 is provided so that the automatic operation of the rear window shade 28 only takes place when the greenhouse effect interferes with the comfort of the occupants of the vehicle.

The temperature sensor 46 signals the interior temperature of the vehicle to the control arrangement 34. If the interior temperature lies below a threshold preset in the control arrangement 34, the control arrangement 34 ignores a signal from the sun sensor 45 if the latter signals a strong influx of sunlight. Only when the interior temperature signaled by the temperature sensor 46 is exceeded does the control arrangement 34 control the rear window shade 28, as described above, in accordance with the signal coming from the light sensor 45.

Since similar interior temperatures can be caused by the vehicle heater or the influx of sunlight, it can be practical to additionally check the operational status of the heater, or the air conditioner, and to trigger the automatic control in accordance with the signal provided by the light sensor 45 only if the temperature in the vehicle interior has been reached without the vehicle heater.

In the reverse manner it can also be useful to activate the automatic control via the light sensor 45 if the temperature reported by the temperature sensor 46 is lower than the set threshold value, provided the air conditioning is set to cooling.

The extended rear window shade 28 not only prevents an excessive influx of sunlight through the rear window 5, but also hampers to some degree the view toward the back through the rear window 5. This is not important during normal driving operations, but can constitute considerable interference when backing up.

Therefore, with the well-appointed control here described, the position of the gearshift, or gear selection lever is checked with the aid of the switch 48. When the driver selects the reverse gear, the switch 48 is closed, which causes the control arrangement 34 to switch on the motor current at the current output 36, namely with a polarity leading to retracting the window shade web.

Depending on how the control arrangement 34 is designed, switching-on the motor current at the input 36 because of the closing of the switch 48 can be made dependent on whether or not the control arrangement 34 had previously extended the rear window shade 28.

Depending on the programming of the control arrangement 24, after disengaging the reverse gear to open the switch 48, the rear window shade 28 can either remain open, or it can be brought back into the operating position which existed prior to engaging the reverse gear.

In place of a mechanical switch 48 it is also possible to employ a magnetoresistor or a Hall probe in connection with a small permanent magnet for scanning the gearshift, or gear selection lever. In connection with an electrical gear-shifting device the signal provided by the switch 48 can also be an electrical signal, which is directly supplied by the gear-shifting device. In this case the additional switch 48 is not required.

In vehicles with a large tailgate, the rear window shade 28 can be come damaged when the window shade web 29 is extended and the tailgate is opened. The switch 51 is provided to assuredly prevent such damage. For example, the switch 51 is closed when the tailgate is unlocked. The rear window shade 28 is then immediately retracted and is already completely retracted before the tailgate reaches the completely open position.

It is clear that for converting the above described control procedures, the control arrangement 34 is usefully based on a microprocessor containing its own memory and its own program. Such a solution is advantageous when it is possible to retrofit the vehicle modularly with window shades. It is also easily apparent that the control arrangement 34 can not only operate the rear window shade 28, but also additional side window shades, wherein possibly further light sensors 45 are provided and the control arrangement 34 has a separate current output 36 for each drive motor of each side window shade.

In accordance with FIG. 3, the described control arrangement 34 with the connected signaling means can also be a component of a central vehicle control 53, as shown in a greatly schematized fashion in FIG. 3. For example, the central vehicle control 53 has multi-pole outputs 54, 55 or 56, through which motor actuators for valve displacement, gear actuators for shifting gears, or door locks, all merely mentioned by way of example, are operated.

FIG. 4 shows a simplified flow diagram such as can be run in the control arrangement 34. The program starts at A and initially determines in an interrogation block 57 whether or not the ignition is switched on, which means an interrogation of the signal state at the input 52. If the ignition is switched on, the switch 48, which signals the engagement of reverse gear, is checked. If the ignition is not switched on, this interrogation can be omitted, i.e. if reverse gear is engaged while the ignition is switched off, this has no effect on the status of the rear window shade.

The status of the switch 48 is checked in an interrogation block 58 and has the above mentioned consequences. If the switch 48 has not been operated, the program continues with interrogation blocks 59 and 61, in which the key 41, or 43, which must be manually operated by the driver, is checked. If the key 41 has been actuated, the program moves to an instruction block 62 in which an action is taken to provide current from the current input 35 to the current output 36 for a predetermined length of time, namely current of a polarity corresponding to the extension of the rear window shade 28. From there the program moves to point B, where possibly another program routine is accessed, or a return to the starting point A takes place.

If it had been determined in the interrogation block 61 that the driver had actuated the key 42 for retraction, the program moves to an instruction block 63, which in turn sees to it that the current output 36 receives current from the current input 35, but of a polarity corresponding to the retraction of the window shade web 29. The program subsequently arrives at the program point B as previously mentioned.

If none of the keys 41 and 42 had been actuated, the signal provided by the light or sun sensor 45 is checked in an interrogation block 64. If a strong influx of sun light is detected, the interior temperature, which had been detected with the aid of the temperature sensor 46, is checked in an interrogation block 65. If the temperature lies above a preset value, a determination is subsequently made in an interrogation block 66 whether the heater is switched on. If not, the program branches off to the already explained instruction block 62. Otherwise it continues in an interrogation block 67, where the status of the switch 51 for the tailgate is checked. If the tailgate is closed, the program arrives at the instruction block 63 and opens the rear window shade 28.

If in the interrogation block 65 the program determines that the interior temperature per se is too low for operating the window shade, the program branches off to an interrogation block 68 and checks the status of the air conditioning. If the air conditioning has been switched on, a continued movement through the instruction block 62 takes place, otherwise the program returns to the beginning of the interrogation block 67.

If insufficient influx of sunshine is detected in the interrogation block 64, the program immediately branches off to the input of the interrogation block 67.

FIG. 5 shows the circuit diagram of a very simple comfort control which only responds to sunlight. The control arrangement essentially consists of only one multi-pole switch 71 and an “intelligent” active sun sensor 72.

The sun sensor 72 is designed in such a way that there is no electrical connection between its current supply input 73 and its output 74 if there is little light. However, if the influx of sunlight exceeds a defined threshold value, the connection between the two connectors 73 and 74 becomes a low voltage one for a limited time.

The mechanical switch has several fixed contacts 75, 76, 77, 78, 79 and 81.

The fixed contact 75 is connected with the output 74 of the sun sensor 72. The two fixed contacts 76 and 79, together with the fixed contact 81, are connected to a vehicle ground 82, while the two fixed contacts 77 and 78 are together connected with the on-board net voltage.

A movable contact 83 acts together with the fixed contact 75 which, in the position of rest of the switch 71, actually makes an electrical contact with the contact 75. A further movable contact 84 can be selectively placed into contact with the fixed contacts 76 and 77, while a movable contact 85 is to be connected with the fixed contacts 78 and 79. In the position of rest, the two movable contacts 84 and 85 do not have an electrical connection with the associated fixed contacts 76 and 77, or 78 and 79.

Finally, the switch 71 also contains a movable contact 86 which, in the position of rest of the switch 71, makes an electrical contact with the fixed contact 81. The movable contacts 83 and 84 are together connected with an input terminal 87 of the drive motor 88 for the rear window shade, while the contacts 85 and 86 are connected to another input contact 89.

The circuit operates as follows:

If the user actuates the switch 71, which is spring-biased in the position of rest, for example in such a way that the movable contact 84 touches the fixed contact 76, the current circuit between the contact 77 and the contact 85 is also closed, while the current circuits through the contacts 83 and 86 remain interrupted. The motor receives current via the movable contacts 84 and 85 in such a way that it is put into motion in the direction of an extension of the rear window shade 28. It receives a current until the user releases the switch 71, whereupon the switch 71 returns into the position of rest represented. In this way the current supply for the motor 88 is first switched off, while the rear window shade 28 is retracted.

For retracting the rear window shade, the user actuates the switch 71 in the opposite direction, i.e. the motor 88 is provided with current via the fixed contacts 77 and 79.

If, with the window shade retracted, the sun sensor 72 reports an excessive influx of sunshine, the motor 88 is provided with current via the fixed contacts 75 and 81 in a direction for extending the window shade web. The time during which the motor 88 is supplied with current is controlled by an appropriate time function element in the sun sensor 72.

The invention was explained above by way of window shades. The invention is not limited to such applications. It can also be employed for controlling cover rollers of cargo spaces. For this purpose the door of the cargo space is monitored by means of a door contact in order to retract the cover when the cargo space door is opened. For practical reasons closing should be performed by the user and not automatically.

A window shade control for window shades 17, 28 of motor vehicles contains a control arrangement 23, 71. The control arrangement 23, 71 receives signals from a switch 41, 42, which is to be manually operated by the driver, or vehicle occupant, in order to be able to arbitrarily retract or extend the window shade 17, 28.

Signaling means 45, 46, 48, 51 are additionally provided, which react to other external stimuli in order to bring the respective window shade into a state which best meets the respective reported external stimulus independently of the actuation by the driver.

1. A window shade control for a window shade (17, 28) of a motor vehicle, wherein the window shade (17, 28) is equipped with a powered drive mechanism (88), by means of which a window shade web (18, 29) of the window shade (17, 28) is to be selectively, and at least partially, retracted or extended,
having a control arrangement (34, 71) which is designed in such a way that it is suitable for controlling the drive mechanism (88), and
having first signaling means (45, 46, 48, 51, 72), whose status is stimulus-dependent and which work together with the control arrangement (34) in order to cause the control arrangement (34) to put the drive mechanism (88) into operation or to stop it.

2. The window shade control in accordance with claim 1, characterized in that second signaling means (41, 42, 71) are additionally provided, whose status is to be determined directly by a user of the vehicle in order to cause the control arrangement (34) to put the drive mechanism (88) into operation or to stop it.

3. The window shade control in accordance with claim 1, characterized in that the control arrangement (34, 71) has at least one switch (71).

4. The window shade control in accordance with claim 1, characterized in that the control arrangement (34, 71) has a current supply input (35, 76,,77, 78, 79) and a current output (36, 84, 85), which is provided for connection to the drive mechanism (88) of the window shade (17, 28).

5. The window shade control in accordance with claim 1, characterized in that the control mechanism (34, 71) has a first control input (43, 44, 47, 49, 52, 75, 91), to which a signal from the first signaling means (45, 46, 48, 51, 72) is to be fed, or to which the first-signaling means (45, 46, 48, 51, 72) are connected.

6. The window shade control in accordance with claim 1, characterized in that the control mechanism (34, 71) has a second control input (38, 39), to which a signal from the second signaling means (41, 42, 71) is to be fed, or to which the second signaling means (41, 42, 71) are connected.

7. The window shade control in accordance with claim 1, characterized in that the control arrangement (34) has its own microprocessor.

8. The window shade control in accordance with claim 1, characterized in that the control arrangement (34) is embedded into a central motor vehicle control (53).

9. The window shade control in accordance with claim 1, characterized in that the control arrangement is a part of a program of a motor vehicle control (53).

10. The window shade control in accordance with claim 1, characterized in that the second signaling means (41, 42) comprise at least one switch or key.

11. The window shade control in accordance with claim 1, characterized in that the second signaling means are constituted by a variable program quantity, whose value is defined by at least one switch (41, 42) or key.

12. The window shade control in accordance with claim 1, characterized in that the first signaling means (45, 46, 48, 51, 72) are constituted by at least one switch (48, 51) or key.

13. The window shade control in accordance with claim 1, characterized in that the first signaling means (45, 46, 48, 51, 72) are constituted by a variable program quantity, whose value is defined by at least one switch (48, 51) or key.

14. The window shade control in accordance with claim 1, characterized in that the first signaling means (45, 46, 48, 51, 72) include a sensor (45, 46, 48, 51, 72).

15. The window shade control in accordance with claim 14, characterized in that the sensor (45, 72) is a light-sensitive sensor.

16. The window shade control in accordance with claim 14, characterized in that the sensor (45) is a photodiode.

17. The window shade control in accordance with claim 14, characterized in that the sensor (45) is a photoresistor.

18. The window shade control in accordance with claim 14, characterized in that the sensor (46) is a a heat-sensitive sensor.

19. The window shade control in accordance with claim 14, characterized in that the sensor (46) is a temperature-dependent resistor.

20. The window shade control in accordance with claim 14, characterized in that the sensor (48, 51) is an electromechanical switch.

21. The window shade control in accordance with claim 14, characterized in that the sensor (48, 51) is a magnetic field-dependent sensor.

22. The window shade control in accordance with claim 14, characterized in that the sensor (48, 51) is a magnetoresistor.

23. The window shade control in accordance with claim 14, characterized in that the sensor (48, 51) is a a Hall probe.

24. The window shade control in accordance with claim 1, characterized in that the sensor (45, 46, 48, 51, 72) is arranged at a location which is shaded when the window shade web (18, 29) is extended.

25. The window shade control in accordance with claim 1, characterized in that the control arrangement (34) contains time function elements in such a way that the drive mechanism (88) is put into motion in the reversed movement position after a preset length of time.

26. The window shade control in accordance with claim 1, characterized in that the control arrangement (34, 52) contains a memory in which the previous operating status is stored.
